(19) United States
(12) Patent Application Publication
(10) Pub. No.: US 2026/0059388 A1
(43) Pub. Date: Feb. 26, 2026

(54) QUALITY OF EXPERIENCE-BASED SOURCE AND RADIO PARAMETER CONFIGURATION

(71) Applicant: QUALCOMM Incorporated, San Diego, CA (US)

(72) Inventors: Belal Salama Amin KORANY, San Diego, CA (US); Peerapol TINNAKORNSRISUPHAP, San Diego, CA (US); Prashanth Haridas HANDE, San Diego, CA (US); Miguel GRIOT, La Jolla, CA (US); Yih-Hao LIN, San Diego, CA (US)

(21) Appl. No.: 18/810,344

(22) Filed: Aug. 20, 2024

(51) Int. Cl. H04W 28/18; H04L 5/00; H04W 24/10

(52) U.S. Cl. CPC H04W 28/18; H04L 5/0055; H04W 24/10

(57) ABSTRACT

Methods, systems, and devices for wireless communications are described. A source and radio parameter service (S&RPS) of a wireless communications service may receive one or more inputs, including source encoding parameters from a source entity, link condition information from a radio access network (RAN), measurement reports from the one or more user equipments (UEs), or any combination thereof. The S&RPS may output one or more outputs including source configuration parameters for the source entity to encode application data for the UEs, network configuration parameters for the RAN to communicate the application data to the UEs, or both. The S&RPS may also obtain QoE thresholds for the UEs, and may determine the outputs based on the QoE thresholds and the inputs. The S&RPS may also configure the UEs, the RAN, or both, with respective measurement configurations, and the inputs may be based on the respective measurement configurations.

### FIELD OF TECHNOLOGY

The following relates to wireless communications, including quality of experience (QoE)-based source and radio parameter configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by an apparatus is described. The method may include obtaining source encoding information associated with application data for a user equipment (UE), obtaining link condition information associated with a network entity that supports communications for the UE, outputting an indication of one or more source configuration parameters for encoding the application data for the UE, the one or more source configuration parameters based on the source encoding information and the link condition information, and outputting an indication of one or more network configuration parameters to the network entity for communicating the application data to the UE, the one or more network configuration parameters based on the source encoding information and the link condition information.

An apparatus for wireless communications is described. The apparatus may include one or more memories storing processor executable code, and one or more processors coupled with the one or more memories. The one or more processors may individually or collectively be operable to execute the code to cause the apparatus to obtain source encoding information associated with application data for a UE, obtain link condition information associated with a network entity that supports communications for the UE, output an indication of one or more source configuration parameters for encoding the application data for the UE, the one or more source configuration parameters based on the source encoding information and the link condition information, and output an indication of one or more network configuration parameters to the network entity for communicating the application data to the UE, the one or more network configuration parameters based on the source encoding information and the link condition information.

Another apparatus for wireless communications is described. The apparatus may include means for obtaining source encoding information associated with application data for a UE, means for obtaining link condition information associated with a network entity that supports communications for the UE, means for outputting an indication of one or more source configuration parameters for encoding the application data for the UE, the one or more source configuration parameters based on the source encoding information and the link condition information, and means for outputting an indication of one or more network configuration parameters to the network entity for communicating the application data to the UE, the one or more network configuration parameters based on the source encoding information and the link condition information.

A non-transitory computer-readable medium storing code for wireless communications is described. The code may include instructions executable by one or more processors to obtain source encoding information associated with application data for a UE, obtain link condition information associated with a network entity that supports communications for the UE, output an indication of one or more source configuration parameters for encoding the application data for the UE, the one or more source configuration parameters based on the source encoding information and the link condition information, and output an indication of one or more network configuration parameters to the network entity for communicating the application data to the UE, the one or more network configuration parameters based on the source encoding information and the link condition information.

Some examples of the method, apparatus, and non-transitory computer-readable medium described herein may further include operations, features, means, or instructions for receiving, from the UE, a measurement report associated with the communications for the UE, where the one or more network configuration parameters, the one or more source configuration parameters, or both, may be based on the measurement report.

Some examples of the method, apparatus, and non-transitory computer-readable medium described herein may further include operations, features, means, or instructions for transmitting an indication of a configuration for the measurement report, the configuration indicating one or more measurements for inclusion in the measurement report, where the one or more measurements include at least a quality of experience (QoE) measurement, a round trip time (RTT) measurement, a packet error rate measurement, a frame error rate and jitter measurement, or any combination thereof, and where the measurement report may be received based on the configuration for the measurement report.

Some examples of the method, apparatus, and non-transitory computer-readable medium described herein may further include operations, features, means, or instructions for obtaining a subscription request, where the source encoding information may be obtained and the indication of the one or more source configuration parameters may be outputted based on the subscription request.

Some examples of the method, apparatus, and non-transitory computer-readable medium described herein may further include operations, features, means, or instructions for outputting a link condition measurement configuration, where the link condition information may be obtained based on the link condition measurement configuration, and where the indication of the one or more network configuration parameters may be outputted based on the link condition measurement configuration.

Some examples of the method, apparatus, and non-transitory computer-readable medium described herein may further include operations, features, means, or instructions for obtaining an indication of a QoE threshold for the UE, where the one or more network configuration parameters, the one or more source configuration parameters, or both, may be based on the QoE threshold.

In some examples of the method, apparatus, and non-transitory computer-readable medium described herein, one or more of obtaining the source encoding information, obtaining the link condition information, outputting the indication of the one or more network configuration parameters, and outputting the indication of the one or more source configuration parameters may be periodic communications associated with a respective periodicity.

In some examples of the method, apparatus, and non-transitory computer-readable medium described herein, obtaining the source encoding information may include operations, features, means, or instructions for obtaining, from a network exposure function, forwarded source encoding parameters based on a source server (e.g., application server) associated with the source encoding information being an untrusted source server.

In some examples of the method, apparatus, and non-transitory computer-readable medium described herein, the indication of the one or more source configuration parameters may be outputted to a media transcoding module that may be configured to transcode the communications for the UE based on the one or more source configuration parameters.

Some examples of the method, apparatus, and non-transitory computer-readable medium described herein may further include operations, features, means, or instructions for obtaining an indication of at least a channel quality index (CQI) associated with the UE, a signal to interference plus noise ratio associated with the UE, a packet delay measurement associated with the UE, a hybrid automatic repeat request (HARQ) acknowledgment or not-acknowledgement associated with the UE, or any combination thereof.

In some examples of the method, apparatus, and non-transitory computer-readable medium described herein, obtaining the source encoding information may include operations, features, means, or instructions for obtaining an indication of at least one or more estimated QoE values associated with an upcoming communication for the UE, each estimated QoE value corresponding to one or more candidate bitrates for the upcoming communication for the UE.

In some examples of the method, apparatus, and non-transitory computer-readable medium described herein, outputting the indication of the one or more network configuration parameters may include operations, features, means, or instructions for outputting an indication of at least a modulation and coding scheme associated with the UE, a HARQ policy associated with the UE, a resource scheduling policy associated with the UE, or any combination thereof.

In some examples of the method, apparatus, and non-transitory computer-readable medium described herein, outputting the indication of the one or more source configuration parameters may include operations, features, means, or instructions for outputting an indication of at least an encoding bitrate associated with the communications for the UE, a frame type associated with the communications for the UE, a resolution associated with the communications for the UE, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports quality of experience (QoE)-based source and radio parameter configuration in accordance with one or more aspects of the present disclosure.

FIGS. 2 through 4 show examples of a communications systems that support QoE-based source and radio parameter configuration in accordance with one or more aspects of the present disclosure.

FIG. 5 shows an example of a process flow that supports QoE-based source and radio parameter configuration in accordance with one or more aspects of the present disclosure.

FIGS. 6 and 7 show block diagrams of devices that support QoE-based source and radio parameter configuration in accordance with one or more aspects of the present disclosure.

FIG. 8 shows a block diagram of a communications manager that supports QoE-based source and radio parameter configuration in accordance with one or more aspects of the present disclosure.

FIG. 9 shows a diagram of a system including a device that supports QoE-based source and radio parameter configuration in accordance with one or more aspects of the present disclosure.

FIG. 10 shows a flowchart illustrating methods that support QoE-based source and radio parameter configuration in accordance with one or more aspects of the present disclosure.

### DETAILED DESCRIPTION

Some wireless devices (e.g., a user equipment (UE)) may perform one or more operations that are associated with a quality of experience (QoE) or quality of service (QoS). In some examples, a QoS may be determined by one or more QoS parameters or metrics associated with communications of the wireless device. QoE may be based on the QoS and an experience of a user of the wireless device. For example, a wireless device may receive a payload (e.g., stream a video, receive a message), where the QoS of the payload may be based on a latency of the payload, a quality of the payload, or other metrics, and an experience of a user associated with the payload (e.g., a QoE of the payload) may be based on the QoS. As used herein, QoE and QoS may be interchangeably and techniques herein referring to or based on QoS may refer to or be based on QoE additionally, or in the alternative. In some cases, payloads (e.g., communications) for one or more UEs may be generated at a source entity (e.g., an edge application server (edge AS), a remote server), sent to a radio access network (RAN) (e.g., a network entity, a distributed unit (DU), an enhanced DU (CDU), a RAN entity), and transmitted to the one or more UEs (e.g., from the RAN).

Communicating the payload from the source entity to the RAN and from the RAN to the UE may be based on a QoE framework which may include reporting one or more QoE measurements from the UE to the RAN (e.g., to a network entity). However, the QoE framework may be incapable of dynamically altering the communication of the payload from the source entity to the network entity and from the network entity to the UE to account for dynamic channel conditions between the RAN and the UE. For example, the QoE framework may assume that one or more aspects of the channel or of the payload are static to simplify signal processing, but the one or more aspect may change over time. Additionally, multiple users receiving a payload from the RAN (e.g., or network entity) may experience different channel conditions, and the QoE framework may not allow for allocation of resources (e.g., a bitrate, slots, bandwidth) to different UEs based on the different channel conditions. Thus, a QoE framework that allows for configuring payload parameters and network configuration parameters based on a QoE of one or more UEs may be beneficial.

According to techniques described herein, a wireless communications system may include an entity, such as a source and radio parameter selection service (S&RPS) (e.g., a network entity, at another entity of a wireless communications system). The S&RPS may receive information associated with a payload and associated with QoE of a UE from one or more of a source entity, a RAN (e.g., a DU, an eDU, another portion of the network entity), one or more UEs, an application client, or one or more other entities. The S&RPS may determine and output one or more configuration parameters associated with communications between the source entity, the RAN, and the one or more UEs based on the received information.

For example, the S&RPS may receive (e.g., obtain) an indication of one or more source encoding parameters from the source entity, link condition information from the network entity, a measurement report from the one or more UEs, or any combination thereof. Additionally, or alternatively, the S&RPS may output an indication of one or more source configuration parameters to the source entity for encoding application data for the one or more UEs, an indication of one or more network configuration parameters to the RAN for communicating the application data to the UE, or both. Additionally, or alternatively, the S&RPS may obtain (e.g., receive) one or more QoE thresholds (e.g., one or more threshold values for one or more QoE parameters) from an operations, administration, and management entity (e.g., an OAM) for each of the one or more UEs, and may determine the one or more configuration parameters based on the one or more QoE thresholds.

In some aspects, the S&RPS may configure the one or more UEs, the network entity, or both, with a respective set of measurement and information to report to the S&RPS. Additionally, or alternatively, the S&RPS may receive respective inputs from the one or more UEs, the RAN, and the source entity, as periodic communications with respective periodicities. In some cases, the source entity may communicate with the S&RPS directly (e.g., if the source entity is a trusted source entity), or through a network exposure function (NEF) (e.g., if the source entity is an untrusted source entity). Additionally, or alternatively, the source entity may transmit one or more payloads to a media transcoding module, which may alter payloads from a remote server based on configuration parameters from the S&RPS before sending the payloads to the RAN. Accordingly, a wireless communications system may dynamically alter parameters for communications for one or more UEs to respond to dynamic channel conditions, which may maintain a higher QoE for more UEs in the wireless communications system.

Aspects of the disclosure are initially described in the context of wireless communications systems. Aspects of the disclosure are also described with respect to communication systems and process flows. Aspects of the disclosure are further illustrated by and described with reference to apparatus diagrams, system diagrams, and flowcharts that relate to QoE-based source and radio parameter configuration.

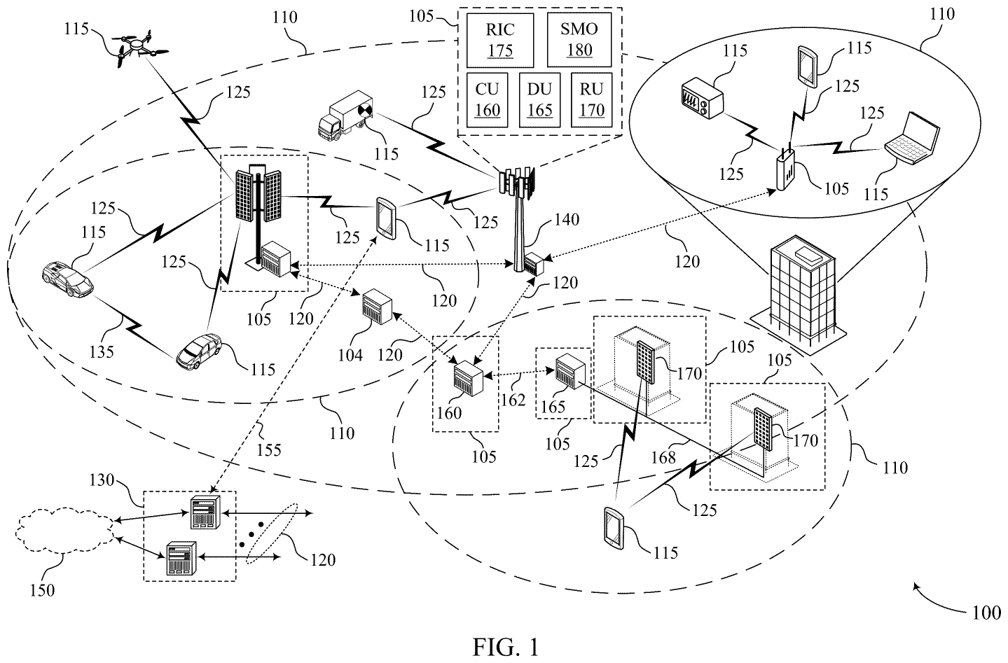

FIG. 1 shows an example of a wireless communications system 100 that supports QoE-based source and radio parameter configuration in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, the wireless communications system 100 may include an entity, such as an S&RPS (e.g., a network entity 105, at another entity of the wireless communications system 100). The S&RPS may receive information associated with a payload and a QoE of one or more UEs 115, where the information may be from one or more of a source entity, a RAN (e.g., a DU, an eDU, another portion of the network entity 105), one or more UEs 115, an application client, or one or more other entities. The S&RPS may determine and output one or more configuration parameters associated with communications between the source entity, the RAN, and the one or more UEs 115 based on the received information.

For example, the S&RPS may receive (e.g., obtain) an indication of one or more source encoding parameters from the source entity, link condition information from the RAN (e.g., network entity 105), a measurement report from the one or more UEs 115, or any combination thereof. Additionally, or alternatively, the S&RPS may output an indication of one or more source configuration parameters to the source entity for encoding application data for the one or more UEs 115, an indication of one or more network configuration parameters to the RAN for communicating the application data to the UEs 115, or both. Additionally, or alternatively, the S&RPS may obtain (e.g., receive) one or more QoE thresholds from an OAM for each of the one or more UEs 115, and may determine the one or more configuration parameters based on the one or more QoE thresholds.

In some aspects, the S&RPS may configure the one or more UEs 115, the RAN (e.g., network entity 105), or both, with a respective set of measurement and information to report to the S&RPS. Additionally, or alternatively, the S&RPS may receive the respective inputs from the one or more UEs 115, the RAN, and the source entity, as periodic communications with respective periodicities. In some cases, the source entity may communicate with the S&RPS directly (e.g., if the source entity is a trusted source entity), or through an NEF (e.g., if the source entity is an untrusted source entity). Additionally, or alternatively, the source entity may transmit one or more payloads to a media transcoding module, which may alter payloads from a remote server based on configuration parameters from the S&RPS before sending the payloads to the RAN. Accordingly, a wireless communications system may dynamically alter parameters for communications for one or more UEs 115 to respond to dynamic channel conditions, which may maintain a higher QoE for more UEs 115 in the wireless communications system 100.

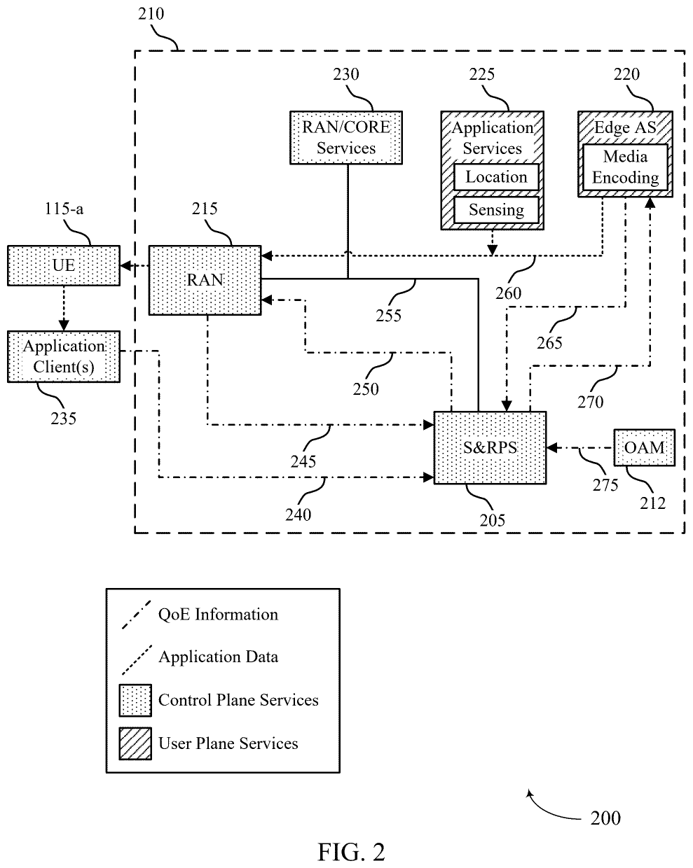

FIG. 2 shows an example of a communications system 200 that supports QoE-based source and radio parameter configuration in accordance with one or more aspects of the present disclosure. In some cases, aspects of the communications system 200 may implement or be implemented by aspects of FIG. 1. For example, the communications system 200 may include a UE 115-a, which may be an example of the UEs 115 described with reference to FIG. 1. The communications system 200 may also include a subsystem 210, which may include one or more components of a network entity 105 or of the wireless communications system 100. For example, the subsystem 210 may include a RAN 215 (e.g., one or more network entities 105 or one or more portions thereof), RAN/control resource (CORE) services 230, application services 225, an edge AS 220, an S&RPS 205, and one or more links (e.g., link 240 through link 275, examples of communication links 125, uplink, downlink, backhaul, other links). The communications system may also include one or more application clients 235 associated with the UE 115-a. In some aspects, the S&RPS 205 may obtain or receive information (e.g., source encoding information, link condition information, measurement reports) from various sources and may configure one or more components of the communications system 200 based on the received information in order to improve QoE associated with one or more UEs 115 (e.g., including the UE 115-a).

Some wireless communications systems may support immersive applications and merging of cyber-physical environments (e.g., virtual reality). Latency (e.g., buffering) may be detrimental to a user experience (UX) or QoE (e.g., QoS) of such applications, which may rely on latency-bound (e.g., real-time) video streaming, for example. However, some QoE frameworks (e.g., 5G QoS framework) and measurements (e.g., coding rate measurements, latency measurements) may be inadequate for effectively supporting such applications.

For example, such QoE frameworks (e.g., and measurements) may be associated with a relatively slow response to channel variations or network loading conditions. In some cases, the QoE frameworks (e.g., 5G compute and multimedia operations) may assume that parts of a communications system (e.g., channel conditions, payload properties) are static. Such an assumption may reduce an ability of the QoE frameworks to account for dynamic conditions of the communications system.

Additionally, or alternatively, distribution of resources to multiple UEs 115 by some QoE frameworks may be improved. For example, a source server (e.g., a source of application data for one or more UEs 115, the edge AS 220) may be unaware of link condition or loading conditions associated with different UEs 115, and a network entity 105 may be unaware of QoEs associated with different UE 115. Such unawareness may cause gaps in bitrates assigned by the network entity 105 to UEs 115 with asymmetric channel conditions. For example, increasing a bitrate allocated to a UE 115 may be associated with diminishing increases to the QoE (e.g., UX) associated with the UE 115. Thus, some UEs 115 (e.g., UEs 115 with good channel conditions) may be assigned high bitrates which may incur relatively small increases to QoE, whereas some UEs 115 (e.g., UEs 115 with poor channel conditions) may be assigned low bitrates, where a small increase of bitrate may incur relatively high increase in QoE. In other words, distributing resources (e.g., bitrate) differently amongst UEs 115 may increase the overall QoE of a wireless communications system.

Additionally, a complexity (e.g., a QoE-bitrate tradeoff function) of some payloads (e.g., video) may be highly dynamic in time. For example, if a payload represents a portion of video data, the complexity may change based on a scene of the video, the amount of motion in a scene, textures in a scene, or other parameters associated with the video data. Thus, a bitrate to maintain a QoE level at a UE 115 while delivering different payloads may change over time. However, such real-time source information (e.g., a complexity of a payload) may be known at the edge AS 220 (e.g., a source server), but may not be available to the communications system 200 (e.g., or to lower layer communication devices) to effectuate the change in bitrate, and consequential improvements to QoE in a wireless communications system.

Additionally, some parameters of the RAN 215 (e.g., a network entity 115) may be configured for improved QoE associated with the UE 115-a based on source information. For example, the RAN 215 may lower an MCS associated with communications with the UE 115-a for better protection of source data, such as key frames of video data or video metadata. However, current QoE frameworks may not account for such source information.

In some cases, the edge AS may provide low latency communications for the UE 115-a. For example, for low latency services, the communications system 200 may allocate computing resources to an edge cloud (e.g., instead of central cloud such as data centers), which may reduce a round-trip time (RTT) latency associated with transmitting the signaling to the UE 115-a. Additionally, the communications system 200 may support RAN virtualization. RAN virtualization may enable “network-as-a-service” by integrating RAN/CORE services 230 as software functions in generic compute clusters within the edge cloud, or collocated with application servers (e.g., such as the edge AS 220, remote application servers). Such collocation of the RAN 215, the RAN/CORE service 230, and application servers (e.g., such as the edge AS 220) at the edge cloud may form the subsystem 210, which may allow for improvements across various communications layers. Additionally, due to the collocation of one or more of the components of the subsystem 210, one or more of the links 240 through 275 may be low latency links (e.g., physical, high speed links).

The techniques described herein may provide a control plane service for joint source and radio parameter selection (e.g., S&RPS) in the communications system 200 (e.g., or the wireless communications system 100). For example, the control plane service may be referred to as the S&RPS 205, and may collect at least network measurements (e.g., from RAN 215 and application client(s) 235 of the UE 115-a) and source measurements (e.g., from applications server(s), such as the edge AS 220). The S&RPS 205 may run one or more algorithms to analyze the collected measurements and determine a combination of source and radio parameters based on one or more QoE thresholds for one or more UEs 115 (e.g., including the UE 115-a). In some cases, the S&RPS 205 may receive the one or more QoE thresholds from an operations, administration, and maintenance (OAM) entity (e.g., OAM 212).

The determined source and radio parameters may be based on information received from the RAN 215, the edge AS 220 (e.g., a source server, a source), and other network functions or services that subscribe to the S&RPS 205. Additionally, the information received at the S&RPS 205 from the edge AS 220 may enable the S&RPS 205 to determine source and radio parameters based on QoE associated with the one or more UEs (e.g., to be QoE-aware). Some example information that may be received or obtained at the S&RPS 205 (e.g., inputs) and may be transmitted or outputted from the S&RPS 205 (e.g., outputs) may be described in Table 1 and Table 2, respectively.

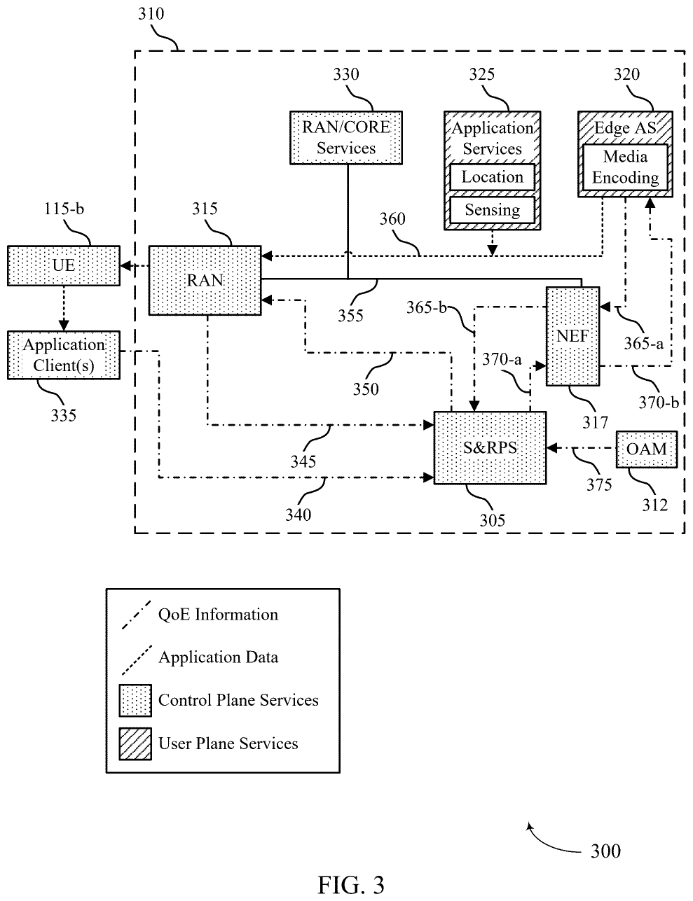

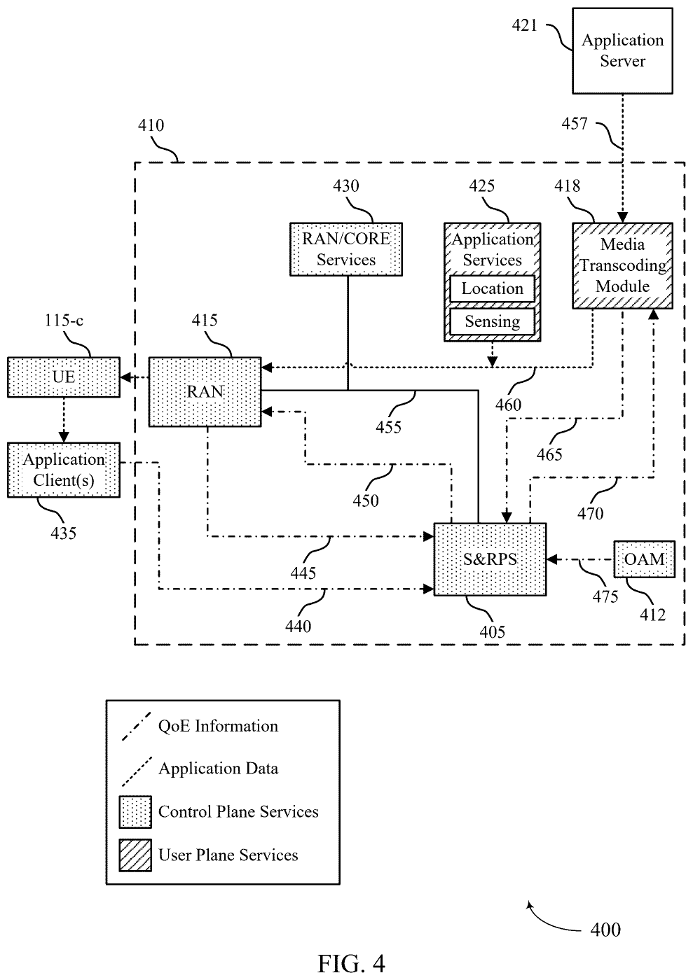

TABLE 1
S&RPS INPUTS

| Input Source(s) | Input Content |
|---|---|
| UE 115-a, Application Client(s) | Measurement reports, including one or |
| 235, Data Collection Client(s) | more of: QoE measurements; RTT |
| (e.g., indirectly through | measurements; packet error rate |
| an application server) | measurement; and other measurements. |
| RAN 215 (e.g., network entity | Link condition information associated |
| 105, eDU, DU) | with each of one or more UEs 115, |
| | including one or more of: quality index |
| | (CQI); signal to interference and noise |
| | ratio (SINR); UE reported measurements; |
| | and loading measurements, such as |
| | packet delay measurements (e.g., |
| | for layer 2 packet). HARQ |
| | acknowledgements or not- |
| | acknowledgements associated with |
| | UEs 115. |
| OAM 212 | One or more QoE thresholds (e.g., |
| | threshold QoE values for QoE |
| | parameters) for each of one or |
| | more UEs 115. |
| Edge AS 220, NEF 317 (e.g., as | QoE-bitrate tradeoff information (e.g., |
| described with respect to FIG. 3), | QoE as a function of bitrate) for different |
| Media Transcoding Module 418 | payloads, estimated QoE values for |
| (e.g., as described with | different bitrates of a payload (e.g., for a |
| respect to FIG. 4) | temporally next frame or segment). |

TABLE 2
S&RPS OUTPUTS

| Output Destination(s) | Output Content |
|---|---|
| RAN 215 (e.g., network | Network configuration parameters, |
| entity 105, eDU, DU) | including: MCS parameters; HARQ |
| | policies; resource scheduling |
| | policies; and others. |
| Edge AS 220, NEF 317 (e.g., as | Source encoding parameters, including: |
| described with respect to FIG. 3), | encoding bitrate parameters; a frame |
| Media Transcoding Module 418 (e.g., | type; a resolution or quality |
| as described with respect to FIG. 4) | for a payload; and others. |

In Table 1, the QoE-bitrate tradeoff information may assist the S&RPS 205 in considering the effect that each parameter may have on QoE associated with the UE 115-a. Additionally, one example of a QoE threshold of Table 1 may be that a video quality is above a threshold quality for 95% of a duration, that a max stall duration is less than 2 frames, or both. Additionally, the outputs of Table 2 may be outputted from the S&RPS 205 on a per UE 115 basis, a per application server (e.g., such as the edge AS 220) basis, for one or more groups of UEs 115, or any combination thereof, such that the S&RPS 205 may coordinate source and radio parameters for multiple UEs 115 in the communications system 200.

The communications system 200 may illustrate an interface between the S&RPS 205 and the edge AS 220 (e.g., link 265 and link 270). For example, when the edge AS 220 (e.g., an application server) is trusted by the S&RPS 205 (e.g., by the network, by the RAN 215, by the OAM 212), the S&RPS 205 may communicate directly with the edge AS 220 via the links 265 and 270. In some examples, the edge AS 220 may be a data service responsible for application compute and media encoding for application data for the UE 115-a. Thus, if the edge AS 220 service is trusted by the S&RPS 205 (e.g., by the network), the edge AS 220 may directly discover and communicate source encoding information and source encoding parameters with the S&RPS 205.

The links 240 through 275 (e.g., low-latency links) may each be for communicating QoE information (e.g., the inputs of Table 1, the outputs of Table 2), for communicating application data, or both. For example, to communicate QoE information, link 240 may convey measurement reports from the application client 235 (e.g., or the UE 115-a) to the S&RPS 205, link 245 may convey the link condition information from the RAN 215 to the S&RPS 205, link 250 may convey network configuration parameters from the S&RPS 205 to the RAN 215, link 265 may convey source encoding information (e.g., as described in Table 1 and elsewhere herein) directly from the edge AS 220 to the S&RPS 205, the link 270 may convey source encoding parameters directly from the S&RPS 205 to the edge AS 220, and the link 275 may convey QoE thresholds from one or more UEs 115 from the OAM 212 to the S&RPS 205. To communicate application data, the link 260 may convey application data from the edge AS 220 (e.g., which may include media encoding abilities) and from the application services 225 (e.g., which may include location and sensing abilities) to the RAN 215, and a link (e.g., downlink) may convey the application data from the RAN 215 to the UE 115-a. Additionally, the link 255 may convey QoE information, Application Data, both, or other signaling between the RAN/CORE services 230, the S&RPS 205, and the RAN 215.

Additionally, the components of the communications system 200 may support one or more of control plane services and user plane services associated with the UE 115-a. For example, the edge AS 220, the application services 225, or both, may support user plane services for the UE 115-a. Additionally, or alternatively, the UE 115-a, the application client 235, the RAN 215 the RAN/CORE services 230, the S&RPS 205, and the OAM 212 may support control plane services for the UE 115-a.

The S&RPS 205 may improve QoE for multi-user scenarios (e.g., with multiple UEs 115 connected to a single subsystem 210), for example, by determining a resource scheduling policy. For example, multiple UEs 115 may be associated with the subsystem 210, and each UE 115 may be associated with one or more application client 235 and one or more edge AS 220. As an example, a first channel between the RAN 215 and a first UE 115 and a second channel between the RAN 215 and a second UE 115 may be associated with good channel conditions. However, a third channel between the RAN 215 and a third UE 115 may be associated with poor channel conditions. In some examples, the first UE 115 and the second UE 115 may maintain high bitrates and QoEs (e.g., or QoSs) based on the good channel conditions, and may meet or exceed respective QoE thresholds. However, the third UE 115 may experience low bitrates based on the poor channel conditions, and may violate a respective QoE threshold.

The S&RPS 205 may determine to reduce bitrates (e.g., by reducing resources) allocated to the first and second UEs 115 based on the first and second UEs 115 meeting or exceeding the respective QoE thresholds, and may reallocate the bitrate to the third UE 115 based on violating the respective QoE threshold. In some cases, due to the diminishing increase to QoE with increasing bitrate, reducing the bitrate for the first and second UEs 115 may not cause the QoEs associated with the first and second UEs 115 to go below the respective QoE thresholds (e.g., the first and second UEs 115 may still meet the respective QoE thresholds). However, allocating the bitrate (e.g., or resources) deallocated from the first and second UEs 115 to the third UE may increase the QoE of the third UE 115, possibly causing the third UE 115 to meet the respective QoE threshold.

In some examples, a bitrate (e.g., an amount of resource) used to maintain a QoE threshold may change over time (e.g., be dynamic), for example, based on current payload complexity (e.g., video complexity) and channel conditions. Thus, based on the inputs to the S&RPS 205, the S&RPS 205 may dynamically determine bitrates for one or more UEs 115 associated with the subsystem 210, which may allow more UEs 115 to satisfy a respective QoE threshold. For example, each edge AS 220 (e.g., or other application servers) of each UE 115 may provide current complexity info (e.g., QoE-bitrate tradeoff, for example) to the S&RPS 205 to determine one or more quantities by which to reduce the bitrates of the first and second UEs 115 without causing QoEs to drop below QoE thresholds. In some cases, the operations ascribed to the S&RPS 205 herein may also be performed by the RAN 215 or one or more other network devices.

In some cases, the S&RPS 205 may perform one or more algorithms to determine parameters for the RAN 215, the edge AS 220, or other components. As an example, one algorithm may be associated with performing the reallocation of bitrate, as described herein. The algorithm may receive inputs of SINRᵢ from the RAN 215 and QoE (Qᵢ) as a function of bitrate (BR) (e.g., QoE-bitrate tradeoff, Q; (BR)) from application servers (e.g., as described in Table 1), where i may represent an index of a UE 115 served by the RAN 215 out of a total quantity of UEs 115 served by the RAN 215 N_{UE}. The algorithm may output an MCS for each UE 115 (MCSᵢ) to the RAN 215 and a bitrate for each UE 115 (BRᵢ) to application servers associated with each UE 115 (e.g., as described in Table 2, as parameters to implement on current or next payloads). After receiving the inputs, the algorithm may set MCS; as a function of SINRᵢ and a target block error rate (BLER), and may set a quantity of slots allocated to a UE 115 (sᵢ) as sᵢ=sₜₒₜₐₗ/N_{UE}, where sₜₒₜₐₗ may be a total available quantity of slots within a set of resources. The algorithm may also calculate Qᵢ (BR(sᵢ, MCSᵢ)) based on one or more tables or relationships between QoE, bitrate, slots, and MCS. If all N_{UE} UEs 115 satisfy a respective QoE threshold, or if all UEs do not satisfy a respective QoE threshold, the algorithm may set BRᵢ=BR (sᵢ, MCSᵢ).

Otherwise (e.g., if some UEs 115 do satisfy respective QoE thresholds and some UEs 115 do not satisfy respective QoE thresholds), the algorithm may divide the UEs 115 into two sets, where a first set

$${U}_{1} = \{ i : {s}_{i} \geq {s}_{i}^{th} \}$$

and a second set

$${U}_{2} = \{ i : {s}_{i} < {s}_{i}^{th} \} ,$$

and where

$${s}_{i}^{th}$$

may be a threshold (e.g., minimum) s such that Qᵢ (s, MCSᵢ)≥Qₜₕᵣₑₛₕ (e.g., a respective QoE threshold). For U₁, the algorithm may calculate an excess quantity of slots as

$${s}_{excess} = {\sum }_{i ∈ {U}_{1}} ( {s}_{i} - {s}_{i}^{th} ) .$$

The algorithm may order the UEs 115 in U₂ by increasing order of their slot shortage

$${s}_{i , shortage} = {s}_{i}^{th} - {s}_{i} ,$$

i∈U₂. The algorithm may increase sᵢ for each UE 115 in order, such that a new quantity of slots for a UE 115 may be s_{i,new}=sᵢ+s_{i,shortage}, and the excess quantity of slots may be decreased by s_{excess}−=s_{i,shortage} until s_{excess}=0. Then, the algorithm may set BRᵢ=BR (s_{i,new}, MCSᵢ).

Using this algorithm (e.g., in combination with other algorithms and techniques), the S&RPS 205 (e.g., or one or more other components, such as the RAN 215) may perform a joint selection of source and radio parameters by a single entity (e.g., the S&RPS 205, the RAN 215) for communications associated with multiple UEs 115, which may improve a total QoE for a wireless communications system.

Additionally, or alternatively, the techniques described herein may adapt a bitrate from application servers (e.g., the edge AS 220, another source) for rapidly-changing channel conditions based on RAN information availability (e.g., the link condition information). Thus, utilizing the S&RPS 205 may provide QoE gains (e.g., improve video quality and smoothness, reduce latency and buffering) for the communications system 200 by increasing a quantity of UEs 115 that a network entity 105 (e.g., the RAN 215) may support while maintaining the respective QoE thresholds for each UE 115 of the quantity of UEs 115.

In some aspects, FIGS. 3 and 4 may provide communications systems that are similar to the communications system 200, but with some differences. To avoid repetition, the descriptions of FIGS. 3 and 4 may highlight the differences of communications systems 300 and 400 compared to the communications system 200 and rely on the description of communications system 200 for descriptions of other aspects.

FIG. 3 shows an example of the communications system 300 that supports QoE-based source and radio parameter configuration in accordance with one or more aspects of the present disclosure. In some cases, aspects of the communications system 300 may implement or be implemented by aspects of FIGS. 1 and 2. For example, components of the communications systems 200 and 300 that are labeled with a same last 2 digits (e.g., such as RAN 315 and the RAN 215, such as the S&RPS 305 and the S&RPS 205) may be similar components and are described herein with respect to FIG. 2. For example, S&RPS 305, subsystem 310, OAM 312, RAN 315, edge AS 320, application services 325, RAN/CORE services 330, application client(s) 335, and links 340, 345, 350, 355, 360, and 375 may be examples of RPS 205, subsystem 210, OAM 212, RAN 215, edge AS 220, application services 225, CORE services 230, client(s) 235, and links 240, 245, 250, 255, 260 and 275, respectively, as described herein with respect to FIG. 2. In addition to the components of FIG. 2, the communications system 300 may include an NEF 317, link 365-a, link 365-b, link 370-a, and link 370-b. In some aspects, S&RPS 305 may obtain or receive some QoE information (e.g., source encoding information) via the NEF 317, and may configure one or more components of the communications system 300 based on the received information in order to improve QoE associated with one or more UEs 115 (e.g., including the UE 115-b).

The communications system 300 may illustrate an interface between the S&RPS 305 and edge AS 320. For example, the edge AS 320 may be untrusted by the S&RPS 305 (e.g., by the network, may be an untrusted source server, may be a 3rd party). The S&RPS 305 may communicate with the untrusted edge AS 320 through NEF 317. For example, the NEF 317 may provide protection to the S&RPS 305, such as detecting, blocking, reporting, or any combination thereof, of incorrect or malicious data or information from the edge AS 320. For example, the link 365-a may convey the source encoding information from the edge AS 320 to the NEF 317, and the NEF 317 may analyze the source encoding information for incorrect or malicious information. The link 365-b may convey the analyzed source encoding information from the NEF 317 to the S&RPS 305 (e.g., in response to the source encoding information being free from errors or malicious information). After determining source encoding parameters (e.g., as described herein with respect to FIG. 2), the link 370-a may convey the source encoding parameters from the S&RPS 305 to the NEF 317, and the link 370-b may convey the source encoding parameters from the NEF 317 to the edge AS 320.

Accordingly, the S&RPS 305 may dynamically provide source and radio parameters to increase QoE in the communications system 300, and the NEF 317 may provide protection to the S&RPS 305 in the case that the edge AS 320 is an untrusted source server.

FIG. 4 shows an example of a communications system 400 that supports QoE-based source and radio parameter configuration in accordance with one or more aspects of the present disclosure. In some cases, aspects of the communications system 300 may implement or be implemented by aspects of FIGS. 1-3. For example, components of the communications systems 200 and 400 that are labeled with a same last 2 digits (e.g., such as RAN 415 and the RAN 215, such as the S&RPS 405 and the S&RPS 205) may be similar components, and are described herein with respect to FIG. 2. For example, S&RPS 405, subsystem 410, OAM 412, RAN 415, edge AS 420, application services 425, RAN/CORE services 430, application client(s) 435, and links 440, 445, 450, 455, 460, 465, 470, and 475 may be examples of RPS 205, subsystem 210, OAM 212, RAN 215, edge AS 220, application services 225, CORE services 230, client(s) 235, and links 240, 245, 250, 255, 260, 265, 270, and 275, respectively, as described herein with respect to FIG. 2. In addition to the components of FIG. 2, the communications system 400 may include a media transcoding module 418, a link 457, and an application server 421 (e.g., a remote application server, an edge AS). In some aspects, S&RPS 405 may obtain or receive information (e.g., source encoding information) via the media transcoding module 418, and may configure the media transcoding module 418 (e.g., instead of the edge AS 220 of FIG. 2) based on the received information in order to improve QoE associated with one or more UEs 115 (e.g., including the UE 115-c).

The communications system 400 may illustrate an interface between the S&RPS 405 and the application server 421 (e.g., a remote server). As the application server 421 may not be part of a subsystem 410, a low-latency link may not exist between the S&RPS 405 and the application server 421. Thus, the S&RPS 405 may not be capable of providing dynamic signaling with sufficient speed (e.g., low-latency) to change a bitrate for the UE 115-c according to dynamic channel and payload conditions.

In order to provide improved QoE at the UE 115-c associated with the application server 421, the S&RPS 405 may communicate with the media transcoding module 418. For example, the application server 421 may send encoded media (e.g., a payload) to the media transcoding module 418 at a full bitrate (e.g., a highest bitrate supported by the UE 115-c, a highest bitrate available for the encoded media). The media transcoding module 418 may output, via the link 465, source encoding information to the S&RPS 405, and the S&RPS 405 may output, via the link 470, source encoding parameters (e.g., as described herein with respect to FIGS. 2 and 1) to the media transcoding module 418. The media transcoding module 418 (e.g., a media transcoding data service) may adaptively transcode the full bitrate media (e.g., change a bitrate of the encoded data from the full bitrate to a second bitrate) based on the source encoding parameters, which may provide improved QoE to the UE 115-c (e.g., or one or more other UEs 115).

In some cases, if the media transcoding module 418 is trusted by the S&RPS 405 (e.g., by the network), the media transcoding module 418 may directly discover and communicate with the S&RPS 405. Additionally, or alternatively, if the media transcoding module 418 is not trusted by the S&RPS 405, the S&RPS 405 may communicate with the media transcoding module 418 via an NEF (e.g., as described with respect to FIG. 3, as the S&RPS 305 and the edge AS 320 communicate via the NEF 317). Accordingly, the S&RPS 405 may dynamically provide source and radio parameters to increase QoE in the communications system 300, where the source parameters may be implemented by the media transcoding module 418 in the event that an application server 421 is a remote application server (e.g., or otherwise not coupled with the S&RPS 405 via a low-latency link).

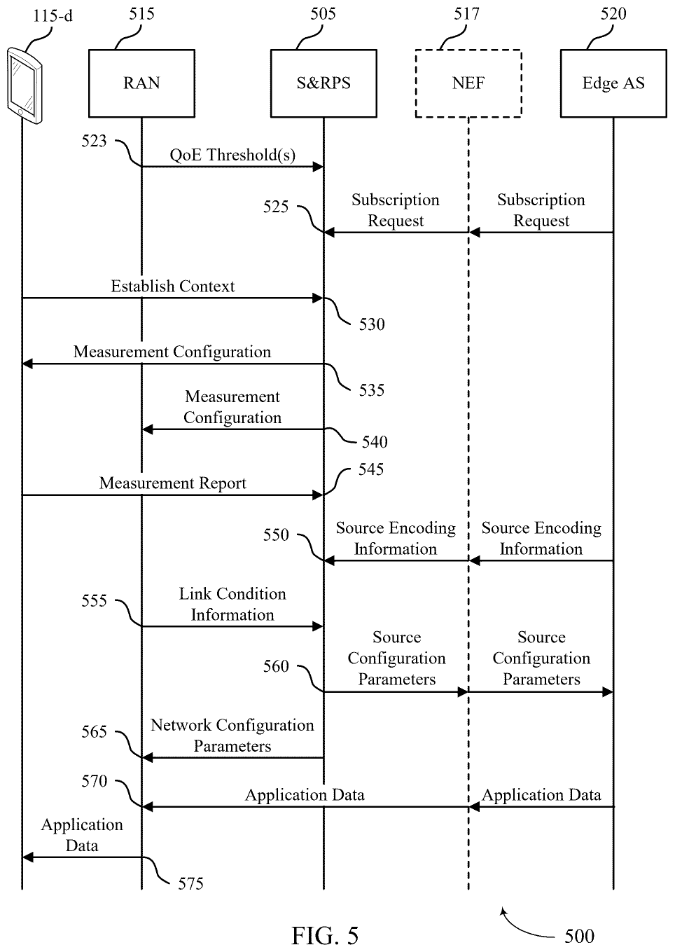

FIG. 5 shows an example of a process flow 500 that supports QoE-based source and radio parameter configuration in accordance with one or more aspects of the present disclosure. In some cases, aspects of the process flow 500 may implement or be implemented by aspects of FIGS. 1-4. For example, the process flow 500 may include a UE 115-c, a RAN 515 (e.g., a DU, an eDU), an S&RPS 505, an edge AS 520, and an NEF 517, which may be examples of the UEs 115, the RAN 215 (e.g., or network entities 105), the S&RPS 205, the edge ASs 220 (e.g., or the application server 421), and the NEF 317, respectively, as described herein with respect to FIGS. 1-4. The process flow 500 may illustrate one or more operations that occur in a communications system (e.g., such as the communications systems 200, 300, and 400). In some aspects, the S&RPS 505 may aggregate QoE (e.g., QoS) information associated with the UE 115-c, and may output (e.g., transmit) one or more source and radio parameters (e.g., configurations) to the RAN 515, the edge AS 520, or both, to improve QoE associated with the UE 115-c (e.g., or one or more other UEs 115).

In the following description of process flow 500, the operations may be performed in a different order than the order shown, or other operations may be added or removed from the process flow 500. For example, some operations may also be left out of process flow 500, may be performed in different orders or at different times, or other operations may be added to process flow 500. Although the UE 115-c, the RAN 515, the S&RPS 505, the edge AS 520, and the NEF 517 are shown performing the operations of process flow 500, some aspects of some operations may also be performed by one or more other wireless devices or network devices. For example, the NEF 517 may be an optional aspect of the process flow 500 (e.g., as described herein with respect to FIG. 3), and may, in some examples, be replaced with or in addition to the media transcoding module 418 (e.g., as described herein with respect to FIG. 4). Additionally, or alternatively, one or more of the operations performed by the UE 115-d (e.g., receiving, transmitting) may also be performed by an application client or data collection client (e.g., such as the application client(s) 235 described with respect to FIG. 2). Additionally, or alternatively, one or more operations performed by the S&RPS 505 may be performed by the RAN 515 or a network entity 105.

At 523, the S&RPS 505 may obtain (e.g., from the RAN 515, form an OAM) an indication of one or more QoE thresholds for one or more UEs including the UE 115-d. For example, the one or more QoE thresholds may include one or more threshold values for one or more QoE parameters, where the one or more QoE parameters may include parameters associated with latency, signal quality, channel quality, or other aspects of the functioning of the one or more UEs.

At 525, the S&RPS 505 may obtain a subscription request. For example, the subscription request may indicate one or more parameters or identifiers associated with the edge AS 520, and may request communications between the S&RPS 505 and the edge AS 520. In some examples, such as when the edge AS 520 (e.g., a source server associated with source encoding information) is a trusted source server (e.g., trusted by the S&RPS 505), the S&RPS 505 may obtain the subscription request directly from the edge AS 520. Additionally, or alternatively, the S&RPS 505 may obtain, from the NEF 517, a forwarded subscription request based on the edge AS 520 being an untrusted source server. That is, the edge AS 520 may transmit the subscription request to the NEF 517 based on being an untrusted server, and the NEF 517 may forward the subscription request to the S&RPS 505 (e.g., as described herein with respect to FIG. 3).

At 530, the UE 115-d may establish a context with the S&RPS 505. For example, to establish the context, the UE 115-d may transmit one or more identifiers of the UE 115-d to the S&RPS 505, as well as one or more parameters associated with the UE 115-d.

At 535, the S&RPS 505 may transmit (e.g., to the UE 115-d) an indication of a first measurement configuration (e.g., a configuration for a measurement report). In some cases, the S&RPS 505 may transmit the indication of the first measurement configuration in response to establishing the context with the UE 115-d (e.g., at 530). In some examples, the first measurement configuration may indicate one or more measurements for inclusion in a measurement report from the UE 115-d, where the one or more measurements may include at least a QoE measurement (e.g., a measurement of one or more QoE parameters), an RTT measurement, a packet error rate measurement, a frame error rate and jitter measurement, or any combination thereof (e.g., the inputs described herein from the UE 115 in Table 1). The first measurement configuration may indicate one or more other measurements made by a UE 115 to measure communication quality or QoE. Additionally, or alternatively, the first measurement configuration may indicate one or more resources, a periodicity, or both, associated with communication of the measurement report.

At 540, the S&RPS 505 may output (e.g., to the RAN 515) an indication of a second measurement configuration (e.g., a link condition measurement configuration). In some examples, the second measurement configuration may indicate one or more measurements for inclusion in reported link condition information (e.g., from the RAN 515), where the one or more measurements may include at least one or more of the measurements listed at 535. Additionally, or alternatively, the one or more measurements may include a CQI associated with the UE 115-d (e.g., and each UE 115 receiving signaling from the RAN 515), a SINR associated with the UE 115-d, a packet delay measurement associated with the UE 115-d, a HARQ acknowledgment or not-acknowledgement associated with the UE 115-d, or any combination thereof (e.g., the inputs from the RAN 215 described in Table 1). Additionally, or alternatively, the second measurement configuration may indicate a periodicity associated with reporting the link condition information.

At 545, the S&RPS 505 may receive, from the UE 115-d, a measurement report associated with communications for the UE 115-d. In some cases, the S&RPS 505 may receive the measurement report based on the configuration for the measurement report. For example, the measurement report may include one or more measurements indicated in the first measurement configuration, may be received according to the resources, periodicity, or both, indicated by the first measurement configuration, or both.

At 550, the S&RPS 505 may obtain source encoding information associated with application data for the UE 115-d (e.g., and one or more other UEs 115). In some examples, the S&RPS 505 may obtain the source encoding information based on the subscription request (e.g., at 525). In some cases (e.g., if the edge AS 520 is a trusted source server), the S&RPS 505 may obtain the source encoding information directly from the edge AS 520. Additionally, or alternatively, the S&RPS 505 may obtain forwarded source encoding parameters from the NEF 517 based on edge AS being an untrusted source server (e.g., untrusted by the S&RPS 505, as described herein at 525).

At 555, the S&RPS 505 may obtain (e.g., from the RAN 515) link condition information associated with a network entity 105 (e.g., of the RAN 515) that supports (e.g., transmits, configures) communications for the UE 115-d. In some cases, the S&RPS 505 may obtain the link condition information based on the link condition measurement configuration. For example, the 505 may obtain the link condition information according to the periodicity indicated in the second measurement configuration. Additionally, or alternatively, the link condition information may include an indication of at least a CQI associated with the UE 115-d, a SINR associated with the UE 115-d, a packet delay measurement associated with the UE 115-d, a HARQ acknowledgment or not-acknowledgement associated with the UE 115-d, or any combination of the measurements indicated in the second measurement configuration.

At 560, the S&RPS 505 may output an indication of one or more source configuration parameters for encoding the application data for the UE. The one or more source configuration parameters may be based on the source encoding information, the link condition information, the measurement report from the UE 115-d, the QoE threshold for the UE 115-d (e.g., of 523), or any combination thereof. Additionally, or alternatively, the S&RPS 505 may output the indication of the one or more source configuration parameters based on the subscription request of 525. In some cases, the 505 may output the indication of the one or more source configuration parameters to a media transcoding module that is configured to transcode the communications for the UE 115-d based on the one or more source configuration parameters (e.g., as described herein with respect to FIG. 4). Additionally, or alternatively, the S&RPS 505 may output the source configuration parameters directly to the edge AS 520 (e.g., or the media transcoding module, if the edge AS 520 or media transcoding module are trusted), or may output the source configuration parameters to the NEF 517 (e.g., if the edge AS 520 is an untrusted source server) and the NEF 517 may forward the source configuration parameters to the edge AS 520 (e.g., or to the media transcoding module).

The source configuration parameters may include one or more configurations for improving QoE at one or more UEs 115 (e.g., including the UE 115-d). For example, outputting the indication of the one or more source configuration parameters may include outputting an indication of at least an encoding bitrate associated with the communications for the UE 115-d (e.g., and one or more other UEs 115, BRᵢ), a frame type associated with the communications for the UE 115-d, a resolution associated with the communications for the UE 115-d, or any combination thereof. In some examples, the edge AS 520 (e.g., or the media transcoding module 418 described herein with respect to FIG. 4) may implement the one or more source configuration parameters to improve the QoE at the UE 115-d.

At 565, the S&RPS 505 may output an indication of one or more network configuration parameters to the network entity (e.g., of the RAN 515) for communicating application data from the edge AS to the UE 115-d. The one or more network configuration parameters may be based on the source encoding information, the link condition information, the measurement report from the UE 115-d, the QoE threshold for the UE 115-d (e.g., of 523), or any combination thereof. Additionally, or alternatively, the S&RPS 505 may output the indication of the one or more network configuration parameters based on the link condition measurement configuration.

The network configuration parameters may include one or more configurations for the RAN 515 (e.g., the network entity 105) for improving QoE at one or more UEs 115 (e.g., including the UE 115-d). For example, outputting the indication of the one or more network configuration parameters may include outputting an indication of at least an MCS associated with the UE 115-d (e.g., and the one or more other UEs, MCSᵢ), a HARQ policy associated with the UE 115-d, a resource scheduling policy associated with the UE 115-d, or any combination thereof.

In some cases, the signaling of process flow 500 may be according to one or more periodicities. For example, one or more of receiving the measurement report from the UE 115-d (e.g., at 545), obtaining the source encoding information (e.g., at 550), obtaining the link condition information (e.g., at 555), outputting the indication of the one or more network configuration parameters (e.g., at 565), and outputting the indication of the one or more source configuration parameters (e.g., at 560) may be periodic communications associated with respective periodicities. For example, the measurement report from the UE 115-d may be associated with a first periodicity (e.g., every 100 ms), the source encoding information may be associated with a second periodicity (e.g., more frequent than the first periodicity), and the link condition information may be associated with a third period (e.g., more frequent than the first periodicity and the second periodicity, each uplink slot).

Additionally, or alternatively, the source configuration parameters and the network configuration parameters may be associated with a same or different periodicities. For example, the S&RPS 505 may transmit the source configuration parameters and the network configuration parameters at a same time (e.g., simultaneously, according to a same periodicity), or at different times (e.g., separately, according to different periodicities). For example, the network configuration parameters may be associated with a first periodicity that is more frequent than a second period (e.g., 1/frames per second (FPS)) associated with the source configuration parameters.

At 570, the edge AS 520 may output application data to the RAN 515 (e.g., to the network entity 105 associated with communications for the UE 115-d) based on the one or more source configuration parameters. In some cases, the edge AS 520 may output the application data to the NEF 517, where the NEF 517 may output the application data to the RAN 515 (e.g., as described herein with respect to FIG. 3). Additionally, or alternatively, the edge AS 520 may send the application data to a media transcoding module, which may update the application data based on the source configuration parameters and output the updated application data to the RAN 515 (e.g., as described herein with respect to FIG. 4).

At 575, the RAN 515 (e.g., a network entity 105 associated with communications for the UE 115-d) may transmit the application data to the UE 115-d based on the one or more network configuration parameters. In some cases, based on the operations described with respect to the process flow 500, the UE 115-d (e.g., and one or more other UEs 115) may experience improved QoE associated with the application data.

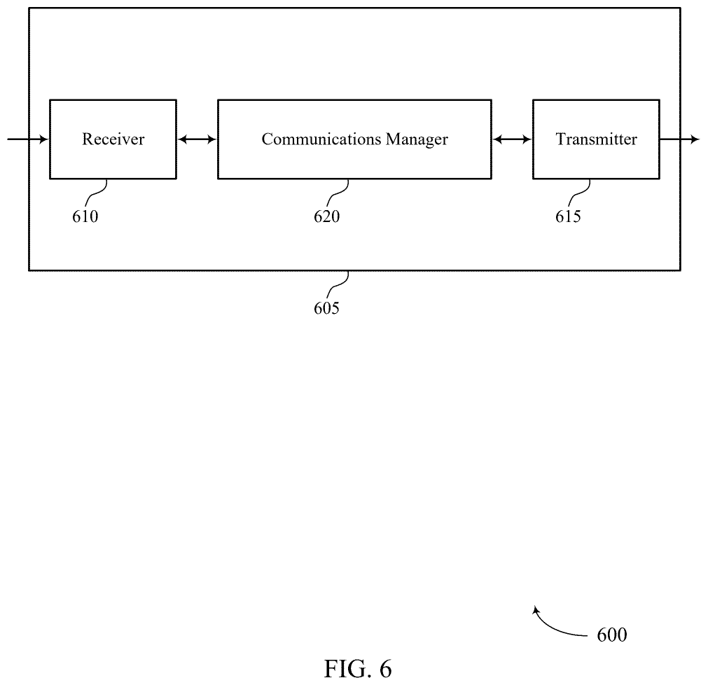

FIG. 6 shows a block diagram 600 of a device 605 that supports QoE-based source and radio parameter configuration in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of QoE-based source and radio parameter configuration as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for obtaining source encoding information associated with application data for a UE. The communications manager 620 is capable of, configured to, or operable to support a means for obtaining link condition information associated with a network entity that supports communications for the UE. The communications manager 620 is capable of, configured to, or operable to support a means for outputting an indication of one or more source configuration parameters for encoding the application data for the UE, the one or more source configuration parameters based on the source encoding information and the link condition information. The communications manager 620 is capable of, configured to, or operable to support a means for outputting an indication of one or more network configuration parameters to the network entity for communicating the application data to the UE, the one or more network configuration parameters based at least in part on the source encoding information and the link condition information.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources. For example, a network entity 105 (e.g., or other RAN component) supporting the techniques herein may distribute resources (e.g., bitrate) amongst UEs 115, allowing for a larger quantity of UEs 115 to satisfy respective QoE thresholds via a same network entity 105.

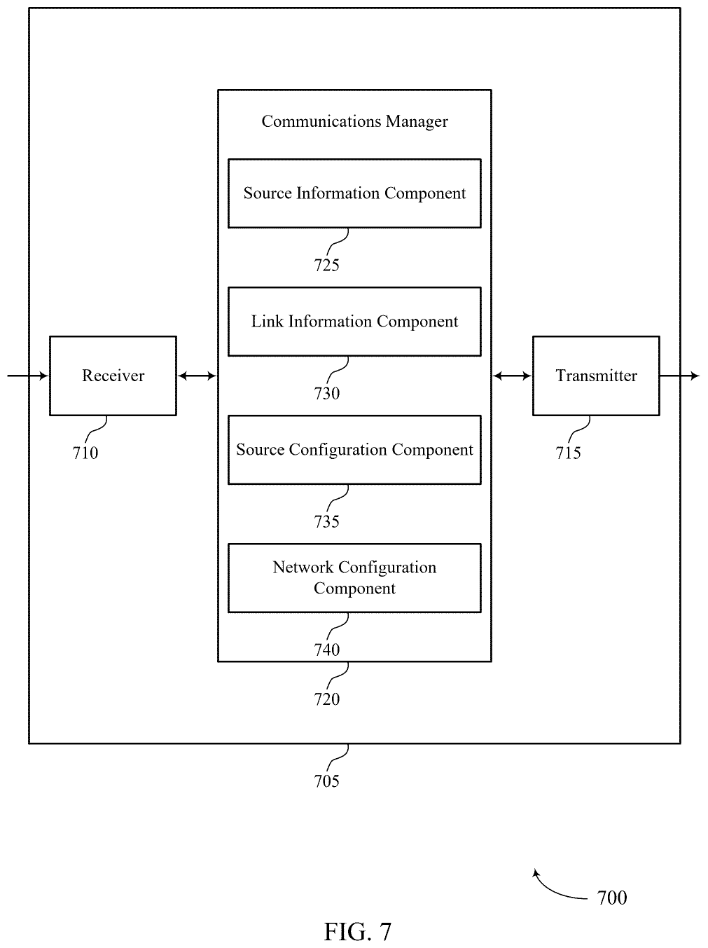

FIG. 7 shows a block diagram 700 of a device 705 that supports QoE-based source and radio parameter configuration in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of QoE-based source and radio parameter configuration as described herein. For example, the communications manager 720 may include a source information component 725, a link information component 730, a source configuration component 735, a network configuration component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The source information component 725 is capable of, configured to, or operable to support a means for obtaining source encoding information associated with application data for a UE. The link information component 730 is capable of, configured to, or operable to support a means for obtaining link condition information associated with a network entity that supports communications for the UE. The source configuration component 735 is capable of, configured to, or operable to support a means for outputting an indication of one or more source configuration parameters for encoding the application data for the UE, the one or more source configuration parameters based on the source encoding information and the link condition information. The network configuration component 740 is capable of, configured to, or operable to support a means for outputting an indication of one or more network configuration parameters to the network entity for communicating the application data to the UE, the one or more network configuration parameters based at least in part on the source encoding information and the link condition information.

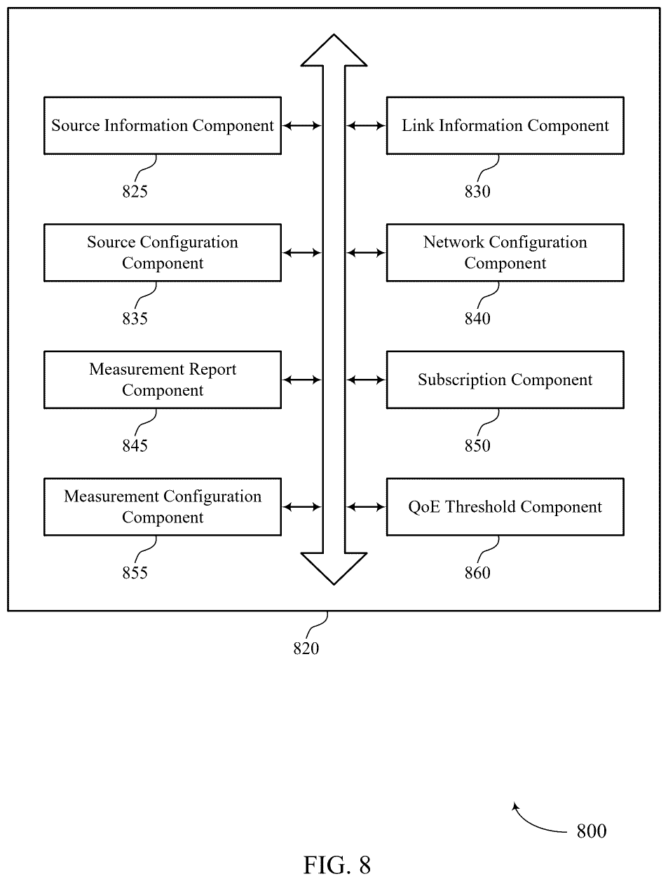

FIG. 8 shows a block diagram 800 of a communications manager 820 that supports QoE-based source and radio parameter configuration in accordance with one or more aspects of the present disclosure. The communications manager 820 may be an example of aspects of a communications manager 620, a communications manager 720, or both, as described herein. The communications manager 820, or various components thereof, may be an example of means for performing various aspects of QoE-based source and radio parameter configuration as described herein. For example, the communications manager 820 may include a source information component 825, a link information component 830, a source configuration component 835, a network configuration component 840, a measurement report component 845, a subscription component 850, a measurement configuration component 855, a QoE threshold component 860, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The source information component 825 is capable of, configured to, or operable to support a means for obtaining source encoding information associated with application data for a UE. The link information component 830 is capable of, configured to, or operable to support a means for obtaining link condition information associated with a network entity that supports communications for the UE. The source configuration component 835 is capable of, configured to, or operable to support a means for outputting an indication of one or more source configuration parameters for encoding the application data for the UE, the one or more source configuration parameters based on the source encoding information and the link condition information. The network configuration component 840 is capable of, configured to, or operable to support a means for outputting an indication of one or more network configuration parameters to the network entity for communicating the application data to the UE, the one or more network configuration parameters based at least in part on the source encoding information and the link condition information.

In some examples, the measurement report component 845 is capable of, configured to, or operable to support a means for receiving, from the UE, a measurement report associated with the communications for the UE, where the one or more network configuration parameters, the one or more source configuration parameters, or both, are based on the measurement report.

In some examples, the measurement configuration component 855 is capable of, configured to, or operable to support a means for transmitting an indication of a configuration for the measurement report, the configuration indicating one or more measurements for inclusion in the measurement report, where the one or more measurements include at least a QoE measurement, a round trip time measurement, a packet error rate measurement, a frame error rate and jitter measurement, or any combination thereof, and where the measurement report is received based on the configuration for the measurement report.

In some examples, the subscription component 850 is capable of, configured to, or operable to support a means for obtaining a subscription request, where the source encoding information are obtained and the indication of the one or more source configuration parameters are outputted based on the subscription request.

In some examples, the measurement configuration component 855 is capable of, configured to, or operable to support a means for outputting a link condition measurement configuration, where the link condition information is obtained based on the link condition measurement configuration, and where the indication of the one or more network configuration parameters is outputted based on the link condition measurement configuration.

In some examples, the QoE threshold component 860 is capable of, configured to, or operable to support a means for obtaining an indication of a QoE threshold for the UE, where the one or more network configuration parameters, the one or more source configuration parameters, or both, are based on the QoE threshold.

In some examples, one or more of obtaining the source encoding information, obtaining the link condition information, outputting the indication of the one or more network configuration parameters, and outputting the indication of the one or more source configuration parameters are periodic communications associated with a respective periodicity.

In some examples, to support obtaining the source encoding information, the source information component 825 is capable of, configured to, or operable to support a means for obtaining, from a network exposure function, forwarded source encoding parameters based on a source server associated with the source encoding information being an untrusted source server.

In some examples, the indication of the one or more source configuration parameters is outputted to a media transcoding module that is configured to transcode the communications for the UE based on the one or more source configuration parameters.

In some examples, obtaining an indication of at least a channel quality index associated with the UE, a signal to interference plus noise ratio associated with the UE, a packet delay measurement associated with the UE, a hybrid automatic repeat request acknowledgment or not-acknowledgement associated with the UE, or any combination thereof.

In some examples, to support obtaining the source encoding information, the source information component 825 is capable of, configured to, or operable to support a means for obtaining an indication of at least one or more estimated QoE values associated with an upcoming communication for the UE, each estimated QoE value corresponding to one or more candidate bitrates for the upcoming communication for the UE.

In some examples, to support outputting the indication of the one or more network configuration parameters, the network configuration component 840 is capable of, configured to, or operable to support a means for outputting an indication of at least a modulation and coding scheme associated with the UE, a hybrid automatic repeat request policy associated with the UE, a resource scheduling policy associated with the UE, or any combination thereof.

In some examples, to support outputting the indication of the one or more source configuration parameters, the source configuration component 835 is capable of, configured to, or operable to support a means for outputting an indication of at least an encoding bitrate associated with the communications for the UE, a frame type associated with the communications for the UE, a resolution associated with the communications for the UE, or any combination thereof.

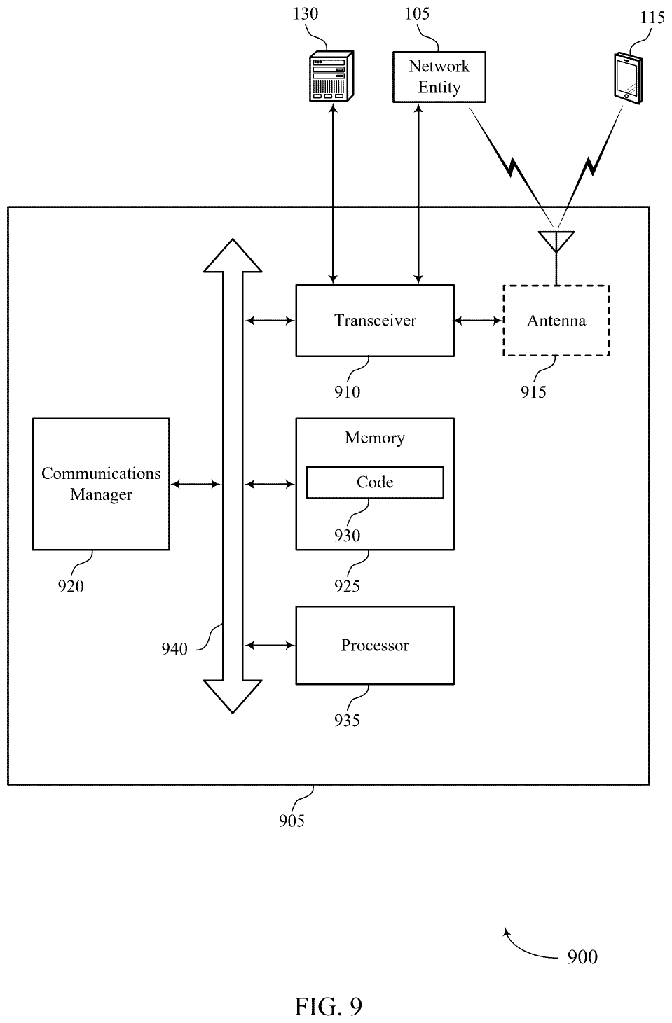

FIG. 9 shows a diagram of a system 900 including a device 905 that supports QoE-based source and radio parameter configuration in accordance with one or more aspects of the present disclosure. The device 905 may be an example of or include components of a device 605, a device 705, or a network entity 105 as described herein. The device 905 may communicate with other network devices or network equipment such as one or more of the network entities 105, UEs 115, or any combination thereof. The communications may include communications over one or more wired interfaces, over one or more wireless interfaces, or any combination thereof. The device 905 may include components that support outputting and obtaining communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting QoE-based source and radio parameter configuration). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for obtaining source encoding information associated with application data for a UE. The communications manager 920 is capable of, configured to, or operable to support a means for obtaining link condition information associated with a network entity that supports communications for the UE. The communications manager 920 is capable of, configured to, or operable to support a means for outputting an indication of one or more source configuration parameters for encoding the application data for the UE, the one or more source configuration parameters based on the source encoding information and the link condition information. The communications manager 920 is capable of, configured to, or operable to support a means for outputting an indication of one or more network configuration parameters to the network entity for communicating the application data to the UE, the one or more network configuration parameters based at least in part on the source encoding information and the link condition information.

By including or configuring the communications manager 920 in accordance with examples as described herein, the device 905 may support techniques for reduced latency and improved user experience. For example, a network entity 105 implementing the techniques described herein may determine one or more parameters for communicating application data with a UE 115 based on current channel and source information, which may reduce a latency associated with the application data. Additionally, a UE 115 implementing the techniques described herein may receive application data according to improved and current network and source parameters, which may reduce a latency and improve a QoE associated with the UE 115.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of QoE-based source and radio parameter configuration as described herein, or the at least one processor 935 and the at least one memory 925 may be otherwise configured to, individually or collectively, perform or support such operations.

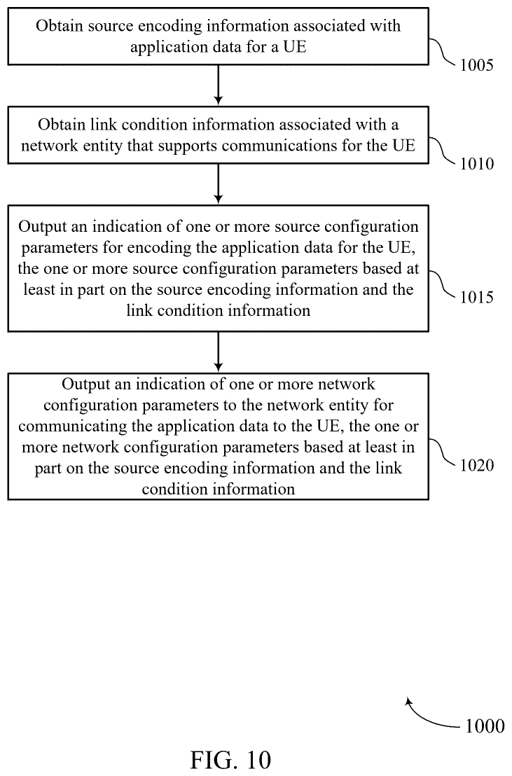

FIG. 10 shows a flowchart illustrating a method 1000 that supports QoE-based source and radio parameter configuration in accordance with one or more aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include obtaining source encoding information associated with application data for a UE. The operations of 1005 may be performed in accordance with examples as disclosed herein. In some examples, aspects of the operations of 1005 may be performed by a source information component 825 as described with reference to FIG. 8.

At 1010, the method may include obtaining link condition information associated with a network entity that supports communications for the UE. The operations of 1010 may be performed in accordance with examples as disclosed herein. In some examples, aspects of the operations of 1010 may be performed by a link information component 830 as described with reference to FIG. 8.

At 1015, the method may include outputting an indication of one or more source configuration parameters for encoding the application data for the UE, the one or more source configuration parameters based at least in part on the source encoding information and the link condition information. The operations of 1015 may be performed in accordance with examples as disclosed herein. In some examples, aspects of the operations of 1015 may be performed by a source configuration component 835 as described with reference to FIG. 8.

At 1020, the method may include outputting an indication of one or more network configuration parameters to the network entity for communicating the application data to the UE, the one or more network configuration parameters based at least in part on the source encoding information and the link condition information. The operations of 1020 may be performed in accordance with examples as disclosed herein. In some examples, aspects of the operations of 1020 may be performed by a network configuration component 840 as described with reference to FIG. 8.

The following provides an overview of aspects of the present disclosure:

Aspect 1: A method for wireless communications, comprising: obtaining source encoding information associated with application data for a UE; obtaining link condition information associated with a network entity that supports communications for the UE; outputting an indication of one or more source configuration parameters for encoding the application data for the UE, the one or more source configuration parameters based at least in part on the source encoding information and the link condition information; and outputting an indication of one or more network configuration parameters to the network entity for communicating the application data to the UE, the one or more network configuration parameters based on the source encoding information and the link condition information.

Aspect 2: The method of aspect 1, further comprising: receiving, from the UE, a measurement report associated with the communications for the UE, wherein the one or more network configuration parameters, the one or more source configuration parameters, or both, are based at least in part on the measurement report.

Aspect 3: The method of aspect 2, further comprising: transmitting an indication of a configuration for the measurement report, the configuration indicating one or more measurements for inclusion in the measurement report, wherein the one or more measurements include at least a QoE measurement, a round trip time measurement, a packet error rate measurement, a frame error rate and jitter measurement, or any combination thereof, and wherein the measurement report is received based at least in part on the configuration for the measurement report.

Aspect 4: The method of any of aspects 1 through 3, further comprising: obtaining a subscription request, wherein the source encoding information are obtained and the indication of the one or more source configuration parameters are outputted based at least in part on the subscription request.

Aspect 5: The method of any of aspects 1 through 4, further comprising: outputting a link condition measurement configuration, wherein the link condition information is obtained based at least in part on the link condition measurement configuration, and wherein the indication of the one or more network configuration parameters is outputted based at least in part on the link condition measurement configuration.

Aspect 6: The method of any of aspects 1 through 5, further comprising: obtaining an indication of a QoE threshold for the UE, wherein the one or more network configuration parameters, the one or more source configuration parameters, or both, are based at least in part on the QoE threshold.

Aspect 7: The method of any of aspects 1 through 6, wherein one or more of obtaining the source encoding information, obtaining the link condition information, outputting the indication of the one or more network configuration parameters, and outputting the indication of the one or more source configuration parameters are periodic communications associated with a respective periodicity.

Aspect 8: The method of any of aspects 1 through 7, wherein obtaining the source encoding information comprises: obtaining, from a network exposure function, forwarded source encoding parameters based at least in part on a source server associated with the source encoding information being an untrusted source server.

Aspect 9: The method of any of aspects 1 through 8, wherein the indication of the one or more source configuration parameters is outputted to a media transcoding module that is configured to transcode the communications for the UE based at least in part on the one or more source configuration parameters.

Aspect 10: The method of any of aspects 1 through 9, wherein obtaining the link condition information includes obtaining an indication of at least a CQI associated with the UE, a signal to interference plus noise ratio associated with the UE, a packet delay measurement associated with the UE, a HARQ acknowledgment or not-acknowledgement associated with the UE, or any combination thereof.

Aspect 11: The method of any of aspects 1 through 10, wherein obtaining the source encoding information comprises: obtaining an indication of at least one or more estimated QoE values associated with an upcoming communication for the UE, each estimated QoE value corresponding to one or more candidate bitrates for the upcoming communication for the UE.

Aspect 12: The method of any of aspects 1 through 11, wherein outputting the indication of the one or more network configuration parameters comprises: outputting an indication of at least a modulation and coding scheme associated with the UE, a HARQ policy associated with the UE, a resource scheduling policy associated with the UE, or any combination thereof.

Aspect 13: The method of any of aspects 1 through 12, wherein outputting the indication of the one or more source configuration parameters comprises: outputting an indication of at least an encoding bitrate associated with the communications for the UE, a frame type associated with the communications for the UE, a resolution associated with the communications for the UE, or any combination thereof.

Aspect 14: An apparatus for wireless communications, comprising one or more memories storing processor-executable code, and one or more processors coupled with the one or more memories and individually or collectively operable to execute the code to cause the apparatus to perform a method of any of aspects 1 through 13.

Aspect 15: An apparatus for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more processors; and
one or more memories coupled with the one or more processors, wherein the one or more memories comprise instructions executable by the one or more processors to cause the apparatus to:
obtain source encoding information associated with application data for a UE;
obtain link condition information associated with a network entity that supports communications for the UE;
output an indication of one or more source configuration parameters for encoding the application data for the UE, the one or more source configuration parameters based at least in part on the source encoding information and the link condition information; and
output an indication of one or more network configuration parameters to the network entity for communicating the application data to the UE, the one or more network configuration parameters based at least in part on the source encoding information and the link condition information.

2. The apparatus of claim 1, wherein the instructions are further executable by the one or more processors to cause the apparatus to:
receive, from the UE, a measurement report associated with the communications for the UE, wherein the one or more network configuration parameters, the one or more source configuration parameters, or both, are based at least in part on the measurement report.

3. The apparatus of claim 2, wherein the instructions are further executable by the one or more processors to cause the apparatus to:
transmit an indication of a configuration for the measurement report, the configuration indicating one or more measurements for inclusion in the measurement report, wherein the one or more measurements include at least a quality of experience measurement, a round trip time measurement, a packet error rate measurement, a frame error rate and jitter measurement, or any combination thereof, and wherein the measurement report is received based at least in part on the configuration for the measurement report.

4. The apparatus of claim 1, wherein the instructions are further executable by the one or more processors to cause the apparatus to:
obtain a subscription request, wherein the source encoding information are obtained and the indication of the one or more source configuration parameters are outputted based at least in part on the subscription request.

5. The apparatus of claim 1, wherein the instructions are further executable by the one or more processors to cause the apparatus to:
output a link condition measurement configuration, wherein the link condition information is obtained based at least in part on the link condition measurement configuration, and wherein the indication of the one or more network configuration parameters is outputted based at least in part on the link condition measurement configuration.

6. The apparatus of claim 1, wherein the instructions are further executable by the one or more processors to cause the apparatus to:
obtain an indication of a quality of experience threshold for the UE, wherein the one or more network configuration parameters, the one or more source configuration parameters, or both, are based at least in part on the quality of experience threshold.

7. The apparatus of claim 1, wherein one or more of obtaining the source encoding information, obtaining the link condition information, outputting the indication of the one or more network configuration parameters, and outputting the indication of the one or more source configuration parameters are periodic communications associated with a respective periodicity.

8. The apparatus of claim 1, wherein the instructions to obtain the source encoding information are executable by the one or more processors to cause the apparatus to:
obtain, from a network exposure function, forwarded source encoding parameters based at least in part on a source server associated with the source encoding information being an untrusted source server.

9. The apparatus of claim 1, wherein the indication of the one or more source configuration parameters is outputted to a media transcoding module that is configured to transcode the communications for the UE based at least in part on the one or more source configuration parameters.

10. The apparatus of claim 1, wherein the instructions to obtain the link condition information are executable by the one or more processors to cause the apparatus to:
obtain an indication of at least a channel quality index associated with the UE, a signal to interference plus noise ratio associated with the UE, a packet delay measurement associated with the UE, a hybrid automatic repeat request acknowledgment or not-acknowledgement associated with the UE, or any combination thereof.

11. The apparatus of claim 1, wherein the instructions to obtain the source encoding information are executable by the one or more processors to cause the apparatus to:
obtain an indication of at least one or more estimated quality of experience values associated with an upcoming communication for the UE, each estimated quality of experience value corresponding to one or more candidate bitrates for the upcoming communication for the UE.

12. The apparatus of claim 1, wherein the instructions to output the indication of the one or more network configuration parameters are executable by the one or more processors to cause the apparatus to:
output an indication of at least a modulation and coding scheme associated with the UE, a hybrid automatic repeat request policy associated with the UE, a resource scheduling policy associated with the UE, or any combination thereof.

13. The apparatus of claim 1, wherein the instructions to output the indication of the one or more source configuration parameters are executable by the one or more processors to cause the apparatus to:
output an indication of at least an encoding bitrate associated with the communications for the UE, a frame type associated with the communications for the UE, a resolution associated with the communications for the UE, or any combination thereof.

14. A method for wireless communications, comprising:
obtaining source encoding information associated with application data for a UE;
obtaining link condition information associated with a network entity that supports communications for the UE;
outputting an indication of one or more source configuration parameters for encoding the application data for the UE, the one or more source configuration parameters based at least in part on the source encoding information and the link condition information; and
outputting an indication of one or more network configuration parameters to the network entity for communicating the application data to the UE, the one or more network configuration parameters based at least in part on the source encoding information and the link condition information.

15. The method of claim 14, further comprising:
receiving, from the UE, a measurement report associated with the communications for the UE, wherein the one or more network configuration parameters, the one or more source configuration parameters, or both, are based at least in part on the measurement report.

16. The method of claim 15, further comprising:
transmitting an indication of a configuration for the measurement report, the configuration indicating one or more measurements for inclusion in the measurement report, wherein the one or more measurements include at least a quality of experience measurement, a round trip time measurement, a packet error rate measurement, a frame error rate and jitter measurement, or any combination thereof, and wherein the measurement report is received based at least in part on the configuration for the measurement report.

17. The method of claim 14, further comprising:
obtaining a subscription request, wherein the source encoding information are obtained and the indication of the one or more source configuration parameters are outputted based at least in part on the subscription request.

18. The method of claim 14, further comprising:
outputting a link condition measurement configuration, wherein the link condition information is obtained based at least in part on the link condition measurement configuration, and wherein the indication of the one or more network configuration parameters is outputted based at least in part on the link condition measurement configuration.

19. The method of claim 14, further comprising:
obtaining an indication of a quality of experience threshold for the UE, wherein the one or more network configuration parameters, the one or more source configuration parameters, or both, are based at least in part on the quality of experience threshold.

20. A non-transitory computer-readable medium storing code for wireless communications, the code comprising instructions executable by one or more processors to:
obtain source encoding information associated with application data for a UE;
obtain link condition information associated with a network entity that supports communications for the UE;
output an indication of one or more source configuration parameters for encoding the application data for the UE, the one or more source configuration parameters based at least in part on the source encoding information and the link condition information; and
output an indication of one or more network configuration parameters to the network entity for communicating the application data to the UE, the one or more network configuration parameters based at least in part on the source encoding information and the link condition information.
